(19) United States
(12) Patent Application Publication
(10) Pub. No.: US 2026/0005226 A1
(43) Pub. Date: Jan. 1, 2026

(54) POWDER MATERIALS, METHODS FOR FORMING THE SAME, AND ELECTRODES FORMED THEREFROM

(71) Applicant: GM GLOBAL TECHNOLOGY OPERATIONS LLC, Detroit, MI (US)

(72) Inventor: Xingcheng Xiao, Troy, MI (US)

(73) Assignee: GM GLOBAL TECHNOLOGY OPERATIONS LLC, Detroit, MI (US)

(21) Appl. No.: 18/754,419

(22) Filed: Jun. 26, 2024

(51) Int. Cl. H01M 4/36; H01M 4/505; H01M 4/525; H01M 4/62

(52) U.S. Cl. CPC H01M 4/366; H01M 4/505; H01M 4/525; H01M 4/628

(57) ABSTRACT

Methods are provided for forming powder materials, and the powder materials and electrodes formed therefrom are also provided. The methods include providing an initial powder having initial particles that each include an electroactive material, coating the initial particles with a doping compound that includes a dopant material to define coated particles of an intermediate powder, exposing the coated particles to a reducing agent that contains fluorine, and performing a heat treatment on the coated particles while exposed to the reducing agent at an elevated temperature and period of time sufficient to cause a solid-state reaction and diffusion of the dopant material into the electroactive material to form a doped region within the electroactive material and thereby define doped particles of a final powder material. The doped region extends at least one nanometer into the electroactive material, and the fluorine reacts with oxides formed on surfaces of the coated particles.

### INTRODUCTION

The technical field generally relates to powder materials, and more particularly relates to powder materials modification and electrodes that include the powder materials and therefore have improved performance in electrochemical cells.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or a solid-state separator), the solid-state electrolyte (or the solid-state separator) may physically separate the electrodes so that a distinct separator is not required.

Many different materials may be used to create components for a lithium-ion battery. For example, in various aspects, positive electrodes may include high nickel content layered oxide electroactive materials, such as various nickel, manganese, cobalt-based layered oxides, which are capable of providing improved specific capacities (e.g., greater than about 250 mAh/g) and improved energy densities. Such materials, however, are often susceptible to capacity fade and loss of thermal stability over time.

Accordingly, it is desirable to develop improved battery materials that can address these challenges. Furthermore, other desirable features and characteristics of the present disclosure will become apparent from the subsequent detailed description and the appended claims, taken in conjunction with the accompanying drawings and the foregoing introduction.

### SUMMARY

A method is provided for forming a powder material. In one example, the method includes providing an initial powder material having initial particles that each include an electroactive material, coating the initial particles with a doping compound that includes a dopant material to define coated particles of an intermediate powder material, exposing the coated particles to a reducing agent, and performing a heat treatment on the coated particles while exposed to the reducing agent at an elevated temperature and period of time sufficient to cause a solid-state reaction and diffusion of the dopant material into the electroactive material to form a doped region within the electroactive material and thereby define doped particles of a final powder material. The doped region extends at least one nanometer into the electroactive material from an outermost surface thereof. The reducing agent reacts with oxides formed on a surface of the coated particles during the heat treatment.

In various examples, the electroactive material may be a nickel-, manganese-, cobalt-based oxide.

In various examples, providing the initial powder material may include: forming a solution of an inorganic solvent and the dopant precursor, mixing the initial powder material into the solution to form a mixture, and drying the mixture to obtain the coated particles of the intermediate powder material, wherein the dopant material is formed from the dopant precursor. In some examples, performing the heat treatment is sufficient to form free radicals from the dopant material and facilitate the diffusion of the free radials into the lattice of the electroactive material.

In various examples, the inorganic solvent may include dimethylformamide (DMF), dimethylacetamide (DMAc), dimethyl sulfoxide (DMSO), tetrahydrofuran (THF), various esters, or acetone.

In various examples, the solution may further include the reducing agent. In various examples, the reducing agent may include fluorine. In various examples, the reducing agent may be a fluoropolymer that includes polyvinylfluoride (PVF), polyvinylidene fluoride (PVDF), polytetrafluoroethylene (PTFE), perfluoroalkoxy polymer (PFA), polychlorotrifluoroethylene (PCTFE), polyethylenetetrafluoroethylene (ETFE), or polyethylenechlorotrifluoroethylene (ECTFE).

In various examples, exposing the coated particles of the intermediate powder material may include exposing the intermediate powder material to a gaseous mixture that includes a fluoro monomer gas and an inert carrier gas. In various examples, the gaseous mixture may include perfluorocycloalkene (PFCA), vinyl fluoride (fluoroethylene) (VF1), vinylidene fluoride (1,1-difluoroethylene) (VDF or VF2), tetrafluoroethylene (TFE), chlorotrifluoroethylene (CTFE), or hexafluoropropylene (HFP).

In various examples, the initial particles of the initial powder material each may include a core material that includes the electroactive material and a coating layer overlying surfaces of the core material. Performing the heat treatment may result in the dopant material being disposed within the core material adjacent to the surfaces thereof and having a concentration of less than 30 at. % within the coating layer.

In various examples, the reducing agent may include fluorine and the fuorine may react with a lithium-containing compound during the heat treatment to form a passivation layer on the doped particles of the final powder material that defines an exterior surface of the doped particles.

In various examples, each of the doped particles of the final powder material may include a coating layer overlying the doped region of the electroactive material, and a passivation layer overlying the coating layer, wherein the passivation layer includes a lithium-based material.

In various examples, the dopant material may include aluminum (Al), magnesium (Mg), titanium (Ti), gallium (Ga), zirconium (Zr), vanadium (V), calcium (Ca), iron (Fe), chromium (Cr), molybdenum (Mo), silicon (Si), yttrium (Y), boron (B), combinations thereof.

In various examples, the method may include forming an electrode that includes a layered oxide structure that includes the doped particles of the final powder material.

A powder material is provided that, in one example, includes particles each including a core material that includes a nickel-, manganese-, cobalt-based oxide, a doped region in the core material that extends at least one nanometer into the core material from an outermost surface thereof, wherein the doped region includes the nickel-, manganese-, cobalt-based oxide and a dopant material diffused therein, wherein the dopant material includes aluminum (Al), magnesium (Mg), titanium (Ti), gallium (Ga), zirconium (Zr), Vanadium (V), Calcium (Ca), Iron (Fe), Chromium (Cr), Molybdenum (Mo), Silicon (Si), Yttrium (Y), boron (B) or combinations thereof, and a coating layer overlying the outermost surface of the core material, wherein the coating layer has a concentration of the dopant material of less than 30 at. %.

In various examples, the powder material may include a passivation layer overlying the coating layer that includes a lithium-based material.

In various examples, the coating layer of the powder material may include carbon or a carbon-based compound.

An electrode is provided that, in one example, includes a layered oxide structure formed of a powder material having particles that each include a core material that includes a nickel-, manganese-, cobalt-based oxide and a coating layer overlying a surface of the core material. The core material includes a dopant material disposed within a doped region of the core material adjacent to the surface thereof. The dopant material includes aluminum (Al), magnesium (Mg), titanium (Ti), gallium (Ga), zirconium (Zr), vanadium (V), calcium (Ca), iron (Fe), chromium (Cr), molybdenum (Mo), silicon (Si), yttrium (Y), boron (B) or combinations thereof. The coating layer has a concentration of the dopant material of less than 30 at. %.

In various examples, the electrode may include a passivation layer overlying the coating layer that includes a lithium-based material.

In various examples, the coating layer of the electrode may include carbon or a carbon-based compound.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a lithium-ion battery in accordance with an example;

FIG. 2 schematically represents a electrochemical cell (e.g., a lithium-ion battery) in accordance with an example;

FIG. 3 schematically represents a particle of a powder material in accordance with an example; and

FIG. 4 is a flowchart illustrating a method for forming a powder material in accordance with an example.

FIG. 5 is a flowchart illustrating a method for coating particles of an electroactive material in accordance with an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

Systems and methods disclosed herein provide for powder materials, electrodes formed from or including the powder materials, electrochemical cells including the electrodes, and methods of forming the powder materials. The cells can be used in vehicle or automotive transportation applications (e.g., motorcycles, boats, tractors, buses, motorcycles, mobile homes, campers, and tanks). However, the systems and methods disclosed herein may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of nonlimiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

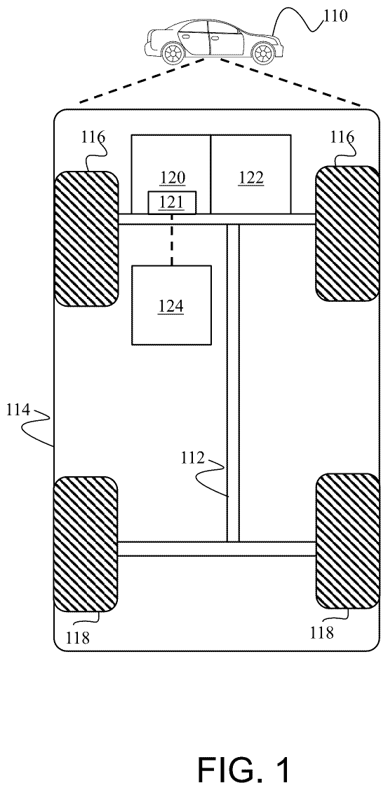

With reference now to FIG. 1, a vehicle 110 is provided according to an exemplary embodiment. In certain examples, the vehicle 110 comprises an automobile. In various examples, the vehicle 110 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain examples.

As depicted in FIG. 1, the exemplary vehicle 110 generally includes a chassis 112, a body 114, front wheels 116, and rear wheels 118. The body 114 is arranged on the chassis 112 and substantially encloses components of the vehicle 110. The body 114 and the chassis 112 may jointly form a frame. The wheels 116, 118 are each rotationally coupled to the chassis 112 near a respective corner of the body 114.

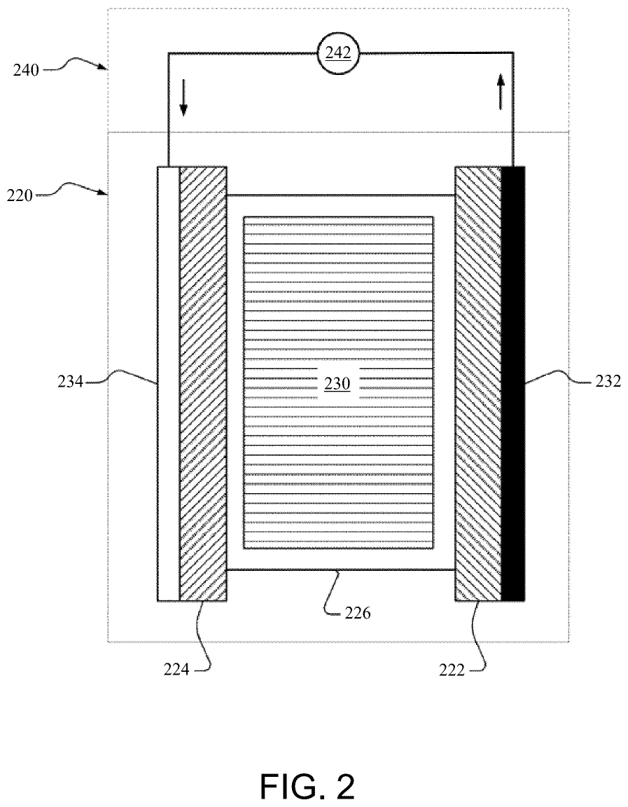

The vehicle 110 further includes a propulsion system 120, a transmission system 122, and at least one lithium-ion battery 124. The propulsion system 120 includes an electric motor 121 or a hybrid electric motor and combustion engine. The transmission system 122 is configured to transmit power from the propulsion system 120 to the wheels 116, 118 according to selectable speed ratios. According to various examples, the transmission system 122 may include a step-ratio automatic transmission, a continuously-variable transmission, or other appropriate transmission. The propulsion system 120 receives electrical power from the at least one lithium-ion battery 124 suitable for powering operation of the propulsion system 120 and/or components thereof (e.g., the electric motor 121). The lithium-ion battery 124 may include one or more lithium-ion electrochemical cells such as the electrochemical cell 220 of FIG. 2.

An exemplary and schematic illustration of an electrochemical cell (also referred to as a battery) 220 is shown in FIG. 2. The cell 220 includes a negative electrode 222 (e.g., anode), a positive electrode 224 (e.g., cathode), and a separator 226 disposed between the two electrodes 222, 224. The separator 226 provides electrical separation and prevents physical contact between the electrodes 222, 224. The separator 226 also provides a minimal resistance path for internal passage of lithium ions, and in certain instances, related anions, during cycling of the lithium ions. In various aspects, the separator 226 comprises an electrolyte 230 that may, in certain aspects, also be present in the negative electrode 222 and/or the positive electrode 224, to form a continuous electrolyte network. In certain variations, the separator 226 may be formed by a solid-state electrolyte or a semi-solid-state electrolyte (e.g., gel electrolyte). For example, the separator 226 may be defined by a plurality of solid-state electrolyte particles. In the instance of solid-state batteries and/or semi-solid-state batteries, the positive electrode 224 and/or the negative electrode 222 may include a plurality of solid-state electrolyte particles. The plurality of solid-state electrolyte particles included in, or defining, the separator 226 may be the same as or different from the plurality of solid-state electrolyte particles included in the positive electrode 224 and/or the negative electrode 222.

A first current collector 232 (e.g., a negative current collector) may be positioned at or near the negative electrode 222. The first current collector 232 together with the negative electrode 222 may be referred to as a negative electrode assembly. Although not illustrated, in certain variations, negative electrodes 222 (also referred to as negative electroactive material layers) may be disposed on one or more parallel sides of the first current collector 232. Similarly, in other variations, a negative electroactive material layer may be disposed on a first side of the first current collector 232, and a positive electroactive material layer may be disposed on a second side of the first current collector 232. In each instance, the first current collector 232 may be a metal foil, metal grid or screen, or expanded metal comprising copper or any other appropriate electrically conductive material.

A second current collector 234 (e.g., a positive current collector) may be positioned at or near the positive electrode 224. The second current collector 234 together with the positive electrode 224 may be referred to as a positive electrode assembly. Although not illustrated, in certain variations, positive electrodes 224 (also referred to as positive electroactive material layers) may be disposed on one or more parallel sides of the second current collector 234. Similarly, in other variations, a positive electroactive material layer may be disposed on a first side of the second current collector 234, and a negative electroactive material layer may be disposed on a second side of the second current collector 234. In each instance, the second current collector 234 may be a metal foil, metal grid or screen, or expanded metal comprising aluminum or any other appropriate electrically conductive material.

The first current collector 232 and the second current collector 234 may respectively collect and move free electrons to and from an external circuit 240. For example, an interruptible external circuit 240 and a load device 242 may connect the negative electrode 222 (through the first current collector 232) and the positive electrode 224 (through the second current collector 234). The cell 220 can generate an electric current during discharge by way of reversible electrochemical reactions that occur when the external circuit 240 is closed (to connect the negative electrode 222 and the positive electrode 224) and the negative electrode 222 has a lower potential than the positive electrode 224. The chemical potential difference between the positive electrode 224 and the negative electrode 222 drives electrons produced by a reaction, for example, the oxidation of intercalated lithium, at the negative electrode 222 through the external circuit 240 toward the positive electrode 224. Lithium ions that are also produced at the negative electrode 222 are concurrently transferred through the electrolyte 230 contained in the separator 226 toward the positive electrode 224. The electrons flow through the external circuit 240 and the lithium ions migrate across the separator 226 containing the electrolyte 230 to form intercalated lithium at the positive electrode 224. As noted above, the electrolyte 230 is typically also present in the negative electrode 222 and positive electrode 224. The electric current passing through the external circuit 240 can be harnessed and directed through the load device 242 until the lithium in the negative electrode 222 is depleted and the capacity of the cell 220 is diminished.

The cell 220 can be charged or re-energized at any time by connecting an external power source to the cell 220 to reverse the electrochemical reactions that occur during battery discharge. Connecting an external electrical energy source to the cell 220 promotes a reaction, for example, non-spontaneous oxidation of intercalated lithium, at the positive electrode 224 so that electrons and lithium ions are produced. The lithium ions flow back toward the negative electrode 222 through the electrolyte 230 across the separator 226 to replenish the negative electrode 222 with lithium (e.g., intercalated lithium) for use during the next battery discharge event. As such, a complete discharging event followed by a complete charging event is considered to be a cycle, where lithium ions are cycled between the positive electrode 224 and the negative electrode 222. The external power source that may be used to charge the cell 220 may vary depending on the size, construction, and particular end-use of the cell 220. Some notable and exemplary external power sources include, but are not limited to, an AC-DC converter connected to an AC electrical power grid though a wall outlet and a motor vehicle alternator.

In many lithium-ion battery configurations, each of the first current collector 232, negative electrode 222, separator 226, positive electrode 224, and second current collector 234 are prepared as relatively thin layers (for example, from several microns to a fraction of a millimeter or less in thickness) and assembled in layers connected in electrical parallel arrangement to provide a suitable electrical energy and power package. In various aspects, the cell 220 may also include a variety of other components including, for example, a casing, gaskets, terminal caps, tabs, battery terminals, and any other conventional components or materials that may be situated within the cell 220, including between or around the negative electrode 222, the positive electrode 224, and/or the separator 226. The cell 220 shown in FIG. 1 includes a liquid electrolyte 230 and shows representative concepts of battery operation. However, the present technology also applies to solid-state batteries and/or semi-solid-state batteries that include solid-state electrolytes and/or solid-state electrolyte particles and/or semi-solid electrolytes and/or solid-state electroactive particles that may have different designs.

The size and shape of the cell 220 may vary depending on the particular application for which it is designed. Battery-powered vehicles and hand-held consumer electronic devices, for example, are two examples where the cell 220 may be designed to different size, capacity, and power-output specifications. The cell 220 may also be connected in series or parallel with other similar lithium-ion cells or batteries to produce a greater voltage output, energy, and power for the load device 242. Accordingly, the cell 220 can generate electric current to a load device 242 that is part of the external circuit 240. The load device 242 may be powered by the electric current passing through the external circuit 240 when the cell 220 is discharging. While the electrical load device 242 may be any number of known electrically-powered devices, a few specific examples include an electric motor for an electrified vehicle, a laptop computer, a tablet computer, a cellular phone, and cordless power tools or appliances. The load device 242 may also be an electricity-generating apparatus that charges the cell 220 for purposes of storing electrical energy.

The porous separator 226 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 226 include CELGARD® 2500 (a monolayer polypropylene separator) and CELGARD® 2320 (a trilayer polypropylene/polyethylene/polypropylene separator) available from Celgard LLC.

When the separator 226 is a microporous polymeric separator, it may be a single layer or a multi-layer laminate, which may be fabricated from either a dry or a wet process. For example, in certain instances, a single layer of the polyolefin may form the entire separator 226. In other aspects, the separator 226 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 226. The separator 226 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 226 as a fibrous layer to help provide the separator 226 with appropriate structural and porosity characteristics.

In certain aspects, the separator 226 may further include one or more of a ceramic material and a heat-resistant material. For example, the separator 226 may also be mixed with the ceramic material and/or the heat-resistant material, or one or more surfaces of the separator 226 may be coated with the ceramic material and/or the heat-resistant material. In certain variations, the ceramic material and/or the heat-resistant material may be disposed on one or more sides of the separator 226. In some examples, the ceramic material may be selected from the group consisting of alumina (Al₂O₃), silica (SiO₂), and combinations thereof. In some examples, the heat-resistant material may be selected from the group consisting of Nomex, Aramid, and combinations thereof.

Various conventionally available polymers and commercial products for forming the separator 226 are contemplated, as well as the many manufacturing methods that may be employed to produce such a microporous polymer separator 226. In some examples, the separator 226 may have an average thickness greater than or equal to about 1 micrometer (μm) to less than or equal to about 50 μm, and in certain instances, optionally greater than or equal to about 1 μm to less than or equal to about 25 μm.

In various aspects, the porous separator 226 and/or the electrolyte 230 disposed in the porous separator 226 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 224 and negative electrode 222. The solid-state electrolyte and/or semi-solid-state electrolyte facilitates transfer of lithium ions, while mechanically separating and providing electrical insulation between the negative and positive electrodes 222, 224. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S, Li2_{S}—P₂S₅, Li₆PS₅Cl, Li₆PS₅Br, Li₆PS₅I, Li₃OCl, Li_{2.99}Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 224 and/or the negative electrode 222. In each instance, the solid-state electrolyte and/or semi-solid-state electrolyte includes the electrolyte additive as detailed above.

The negative electrode 222 is formed from a lithium host material that is capable of functioning as a negative terminal of a lithium-ion battery. In various aspects, the negative electrode 222 may be defined by a plurality of negative electroactive material particles. Such negative electroactive material particles may be disposed in one or more layers to define the three-dimensional structure of the negative electrode 222. The electrolyte 230 may be introduced, for example after cell assembly, and contained within pores of the negative electrode 222. For example, in certain variations, the negative electrode 222 may include a plurality of solid-state electrolyte particles. In some examples, the negative electrode 222 (including the one or more layers) may have a thickness greater than or equal to about 5 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 222 may include a lithium-containing negative electroactive material, such as a lithium alloy and/or a lithium metal. For example, in certain variations, the negative electrode 222 may be defined by a lithium metal foil. In other variations, the negative electrode 222 may include, for example only, carbonaceous materials (such as, graphite, hard carbon, soft carbon, and the like) and/or metallic active materials (such as tin, aluminum, magnesium, germanium, and alloys thereof, and the like). In further variations, the negative electrode 222 may include a silicon-based electroactive material. In still further variations, the negative electrode 222 may be a composite electrode including a combination of negative electroactive materials. For example, the negative electrode 222 may include a first negative electroactive material and a second negative electroactive material. In certain variations, a ratio of the first negative electroactive material to the second negative electroactive material may be greater than or equal to about 5:95 to less than or equal to about 95:5. The first negative electroactive material may be a volume-expanding material including, for example, silicon, aluminum, germanium, and/or tin. The second negative electroactive material may include a carbonaceous material (e.g., graphite, hard carbon, and/or soft carbon). For example, in certain variations, the negative electroactive material may include a carbonaceous-silicon based composite including, for example, about 10 wt. % SiOₓ (where 0≤x≤2) and about 90 wt. % graphite. In some examples, the negative electroactive material may be prelithiated.

In certain variations, the negative electroactive material may be optionally intermingled (e.g., slurry casted) with an electrically conductive material (i.e., conductive additive) that provide an electron conductive path and/or a polymeric binder material that improve the structural integrity of the negative electrode 222. For example, the negative electrode 222 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electrically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrenebutadiene rubber (SBR), lithium polyacrylate (LiPAA), sodium polyacrylate (NaPAA), sodium alginate, and/or lithium alginate. Electrically conducting materials may include, for example, carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (e.g., SuperP (SP)), and the like. Examples of a conductive polymer include polyaniline, polythiophene, polyacetylene, polypyrrole, and the like.

The positive electrode 224 is formed from or includes a lithium-based electroactive material that is capable of undergoing lithium intercalation and deintercalation, alloying and dealloying, or plating and stripping, while functioning as the positive terminal of a lithium-ion battery. The positive electrode 224 can be defined by a plurality of electroactive material particles (e.g., such as the powder materials discussed hereinafter). Such positive electroactive material particles may be disposed in one or more layers to define the three-dimensional structure of the positive electrode 224. The electrolyte 230 may be introduced, for example after cell assembly, and contained within pores of the positive electrode 224. In certain variations, the positive electrode 224 may include a plurality of solid-state electrolyte particles. In some examples, the positive electrode 224 may have an average thickness greater than or equal to about 1 μm to less than or equal to about 500 μm, and in certain aspects, optionally greater than or equal to about 10 μm to less than or equal to about 200 μm.

In various aspects, the positive electrode 224 may be a lithium-rich layered cathode including a positive electroactive material represented by: xLi₂MnO₃·(1-x)LiMO₂ where M are transitions metals (for example, independently selected from the group consisting of: nickel (Ni), manganese (Mn), cobalt (Co), aluminum (Al), iron (Fe), and combinations thereof, and where 0.01≤x≤0.99. In other variations, the positive electrode 224 may be a layered oxide represented by LiMeO₂, where Me is a transition metal, such as cobalt (Co), nickel (Ni), manganese (Mn), iron (Fe), aluminum (Al), vanadium (V), or combinations thereof. For example, the positive electrode 224 may include Li_{1.2}Ni_{0.12}Co_{0.12}Mn_{0.56}O₂ and/or Li_{1.2}Ni_{0.24}Mn_{0.56}O₂.

In other variations, the positive electrode 224 may be a composite electrode including two or more positive electroactive materials. For example, the positive electrode 224 may include a first positive electroactive material and a second positive electroactive material. In certain variations, a ratio of the first positive electroactive material to the second positive electroactive material may be greater than or equal to about 1:9 to less than or equal to about 9:1. The first positive electroactive material may include the lithium-rich, layered positive electroactive material. The second positive electrode material may include, for example, an olivine-type oxide represented by LiMePO₄, where Me is a transition metal, such as cobalt (Co), nickel (Ni), manganese (Mn), iron (Fe), aluminum (Al), vanadium (V), or combinations thereof; a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof; a spinel-type oxide represented by LiMe₂O₄, where Me is a transition metal, such as cobalt (Co), nickel (Ni), manganese (Mn), iron (Fe), aluminum (Al), vanadium (V), or combinations thereof; a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof; and/or combinations thereof.

In some examples, the positive electroactive material may be optionally intermingled (e.g., slurry casted) with an electrically conductive material (i.e., conductive additive) that provide an electron conductive path and/or a polymeric binder material that improve the structural integrity of the positive electrode 224. For example, the positive electrode 224 may include greater than or equal to about 30 wt. % to less than or equal to about 98 wt. %, and in certain aspects, optionally greater than or equal to about 60 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electrically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The conductive additive and/or binder material included in the positive electrode 224 may be the same as or different from the conductive additive as included in the negative electrode 222. In each variation, the cell 220 may have a negative electrode capacity for lithium to positive electrode capacity for lithium (N/P) ratio greater than or equal to about 1 to less than or equal to about 3.

Referring again to FIG. 2, the positive electrode 224, the negative electrode 222, and the separator 226 may each include an electrolyte solution or system 230 inside their pores, capable of conducting lithium ions between the negative electrode 222 and the positive electrode 224. Any appropriate electrolyte 230, whether in solid, liquid, or gel form, capable of conducting lithium ions between the negative electrode 222 and the positive electrode 224 may be used in the cell 220.

In certain aspects, the electrolyte 230 may be a non-aqueous liquid electrolyte solution (e.g., >1 M) that includes a lithium salt dissolved in an organic solvent or a mixture of organic solvents. Numerous conventional nonaqueous liquid electrolyte 230 solutions may be employed in the cell 220. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato) borate (LiB(C₂O₄)₂) (Li-BOB), lithium difluorooxalatoborate (LiBFiC₂O₄)), lithium hexafluoroarsenate (LiAsF₆), lithium trifluoromethanesulfonate (LiCF₃SO₃), lithium bis(trifluoromethane) sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), y-lactones (e.g., y-butyrolactone, y-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

In various aspects, the electrolyte 230 may include a mixture of solvents. The electrolyte 230 may include a first solvent, a second solvent, and a third solvent. For example, the electrolyte 230 may include greater than or equal to about 10 wt. % to less than or equal to about 80 wt. %, and in certain aspects, optionally greater than or equal to about 20 wt. % to less than or equal to about 33 wt. %, of a first solvent; greater than or equal to about 10 wt. % to less than or equal to about 80 wt. %, and in certain aspects, optionally greater than or equal to about 20 wt. % to less than or equal to about 33 wt. %, of a second solvent; and greater than or equal to about 10 wt. % to less than or equal to about 80 wt. %, and in certain aspects, optionally greater than or equal to about 20 wt. % to less than or equal to about 33 wt. %, of a third solvent. In certain variations, the solvents may be independently selected from the group consisting of ethylene carbonate (EC), fluoroethylene carbonate (FEC), dimethyl carbonate (DMC), diethyl carbonate (DEC), ethylmethylcarbonate (EMC), and combinations thereof.

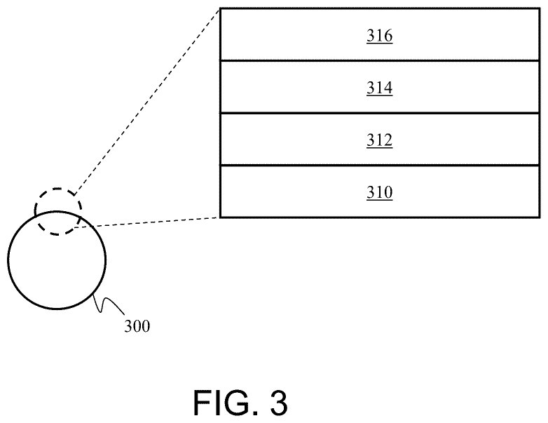

Electrodes of electrochemical cells, such as the positive electrode 224 (or the negative electrode 222) of the cell 220, may be formed of or include powder materials comprising a plurality of particles. For example, the powder materials may be deposited on a current collector as a film to define an electrode having a layered oxide structure. Referring now to FIG. 3, a nonlimiting example of a particle 300 of a powder material is provided that may be used for various applications, including forming electrodes. The particle 300 includes a core material 310, a doped region 312 of the core material 310, a coating layer 314 overlying the doped region 312, and a passivation layer 316 overlying the coating layer 314.

The core material 310 may include an electroactive material for facilitating lithium ion transfer during the charging and discharging processes of an electrochemical cell. In some examples, the core material 310 may define a majority of the particle 300. The core material 310 may include various materials, including those noted above for the positive electrode 224. In some examples, the core material 310 includes or is formed of a nickel-, manganese-, cobalt-based oxide.

The doped region 312 may be formed adjacent to an outermost surface of the core material 310. In some examples, the doped region 312 may be configured to promote stability of the microstructure, mitigate undesirable phase transformations, and improve the diffusion of lithium ions during the charging and discharging processes of an electrochemical cell. In some examples, the doped region 312 may have a substantially uniform thickness about the outermost surface of the core material 310. In some examples, the doped region 312 may have a thickness (i.e., from the outermost surface of the core material 310 into the core material 310) of at least one nanometer, such as between 1 and 50 nanometers. The doped region 312 may include substantially the same material as the core material 310 with one or more dopant materials diffused therein. In some examples, the doped region 312 includes a nickel-, manganese-, cobalt-based oxide with a dopant material diffused therein. The dopant material may include various materials such as, but not limited to, aluminum (Al), magnesium (Mg), titanium (Ti), gallium (Ga), zirconium (Zr), vanadium (V), calcium (Ca), iron (Fe), chromium (Cr), molybdenum (Mo), silicon (Si), yttrium (Y), boron (B), or combinations thereof.

In some examples, the coating layer 314 may be configured to passivate the surface and mitigate the side reactions which typically lead to electrolyte decomposition and gas generation. The coating layer 314 may include various materials and promote various functions. In some examples, the coating layer 314 is formed of or includes carbon or a carbon-based compound. In some examples, the coating layer 314 does not have a significant concentration of the dopant material of the doped region 312. For example, the coating layer 314 may include a concentration of the dopant material of less 30 wt. %, such as 1 to 30 wt. %, such as 5 to 25 wt. % within the coating layer 314.

In some examples, the passivation layer 316 may be configured to reduce and/or prevent reactions between the electrolyte and a transition metal of the electrode (e.g., sufficiently electronic insulating to suppress electrolyte reduction). In some examples, the passivation layer 316 may be configured to reduce the diffusion barrier and charger transfer resistance (e.g., sufficient ionic conduction to enable fast lithium ion transport). The passivation layer 316 (also referred to as the solid electrolyte interphase (SEI)) may include various materials such as but not limited to various lithium-based materials. In some examples, the passivation layer 316 may include carbon (C), lithium fluoride (LiF), and lithium carbonate (Li₂CO₃). In some examples, the passivation layer 316 may consist essentially of carbon (C), lithium fluoride (LiF), and lithium carbonate (Li₂CO₃).

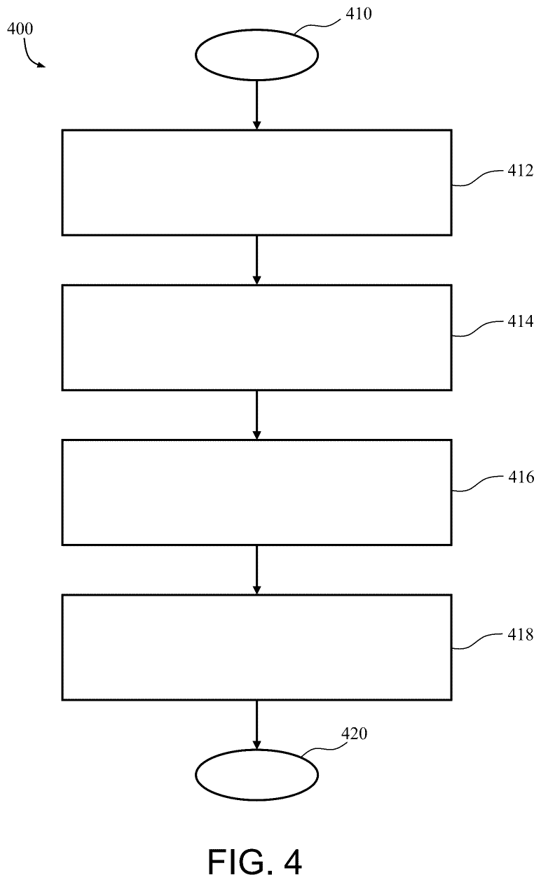

With reference now to FIG. 4 and with continued reference to FIGS. 1-3, a flowchart provides a method 400 for forming a doped powder material, in accordance with various examples. As can be appreciated in light of the disclosure, the order of operation within the method 400 is not limited to the sequential execution as illustrated in FIG. 4, but may be performed in one or more varying orders as applicable and in accordance with the present disclosure. In one example, the method 400 may start at 410.

At 412, the method 400 may include providing an initial powder material having initial particles that each include an electroactive material. In some examples, the initial particles includes or is formed of a nickel-, manganese-, cobalt-based oxide. In some examples, the initial particles may include a core material (e.g., the core material 310) formed of or including an electroactive material and having one or more coating layers thereon (e.g., the coating layer 314). The initial powder material may be formed by various existing methods and therefore such processes will not be discussed in further detail herein.

At 414, the method 400 may include coating the initial particles of the initial powder material with a doping compound that includes a dopant material to define coated particles of an intermediate powder material. The doping compound may include various materials that include the dopant material. In some examples, the dopant material may include aluminum (Al), magnesium (Mg), titanium (Ti), gallium (Ga), zirconium (Zr), and/or vanadium (V), calcium (Ca), iron (Fe), chromium (Cr), molybdenum (Mo), silicon (Si), yttrium (Y), boron (B), or combinations thereof.). Various methods may be used to coat the initial particles with the doping compound.

In some examples, coating the initial particles of the initial powder material may include forming a solution that includes at least a solvent and the dopant material, mixing the initial particles of the initial powder material into the solution to form a mixture (e.g., stirring for about ten minutes or more), and drying the mixture to obtain an intermediate powder material that includes the coated particles (e.g., drying at temperatures greater than 100° C., such as between about 100 and 400° C.). In some examples, the solvent may be a non-aqueous solvent thereby avoiding degradation that may occur when using aqueous solutions. In some examples, the non-aqueous solvent may include N-Methyl-2-pyrrolidone (NMP), dimethylformamide (DMF), dimethylacetamide (DMAc), dimethyl sulfoxide (DMSO), tetrahydrofuran (THF), various esters, or acetone. In some examples, the dopant material may be added to the solvent as an acid. For example, the dopant material may be boron that is added to the solvent as boric acid (H₃BO₃).

At 416, the method 400 may include exposing the coated particles of the intermediate powder material to a reducing agent that contains fluorine. Various reducing agents may be used. In some examples, the reducing agent may be provided in the coating on the coated particles of the intermediate powder material. For example, during the coating process a solution may be prepared that includes the solvent, the dopant material, and the reducing agent. The initial particles may be added to the solution to form a mixture, and the mixture may be dried to form the intermediate powder material with the coated particles. In such examples, the reducing agent may include a fluoropolymer. In some examples, the fluoropolymer may include polyvinylfluoride (PVF), polyvinylidene fluoride (PVDF), polytetrafluoroethylene (PTFE), perfluoroalkoxy polymer (PFA), polychlorotrifluoroethylene (PCTFE), polyethylenetetrafluoroethylene (ETFE), and/or polyethylenechlorotrifluoroethylene (ECTFE).

In some examples, the reducing agent may be a gaseous mixture and the coated particles of the intermediate powder material may be exposed to the gaseous mixture by, for example, flowing the gaseous mixture into a heating apparatus containing the coated particles. In some examples, the gaseous mixture may include a fluoro monomer gas and an inert carrier gas. In various examples, the gaseous mixture may include perfluorocycloalkene (PFCA), vinyl fluoride (fluoroethylene) (VF1), vinylidene fluoride (1,1-difluoroethylene) (VDF or VF2), tetrafluoroethylene (TFE), chlorotrifluoroethylene (CTFE), or hexafluoropropylene (HFP).

At 418, the method 400 may include performing a heat treatment on the coated particles of the intermediate powder material while exposed to the reducing agent at an elevated temperature and period of time sufficient to cause a solid-state reaction and diffusion of the dopant material into the electroactive material (e.g., nickel-, manganese-, cobalt-based oxide) to form a doped region. In some examples, the heat treatment may include calcinating the coated particles of the intermediate powder at temperatures of greater than 400° C. under low pressure conditions (e.g., about 3 to 10 torr) for more than one hour. In some examples, the doped region may extend at least one nanometer into the electroactive material from an outermost surface thereof, such as between 1 and 50 nanometers. In some examples, the doped region has a concentration of the dopant material of about 0.1 at. % to 30 at. %, such as about 1 at. % to 10 at. %. Upon completion of the heat treatment, the intermediate powder material may be converted to a final powder material that includes doped particles.

During the heat treatment, the fluorine from the reducing agent may react with oxides formed on the surface of the coated particles. As such, the reducing agent may function to reduce formation of oxides of the dopant material and form free radicals of the dopant material to facilitate diffusion of the dopant material into the subsurface of the particles. If the coated particles of the intermediate powder material include a coating layer between the dopant compound and the electroactive material, the dopant material may diffuse through the coating layer and into the electroactive material during the heat treatment. In some examples, the dopant material is not present in a significant concentration within the coating layer after the heat treatment. For example, the coating layer may include a concentration of the dopant material of less than 30 at. %. In some examples, a fluoride byproduct may react with lithium-containing compounds, such as lithium carbonate (Li₂CO₃), and thereby form for a composite inorganic artificial SEI on the surfaces of the doped particles of the final powder material.

The method 400 may end at 420.

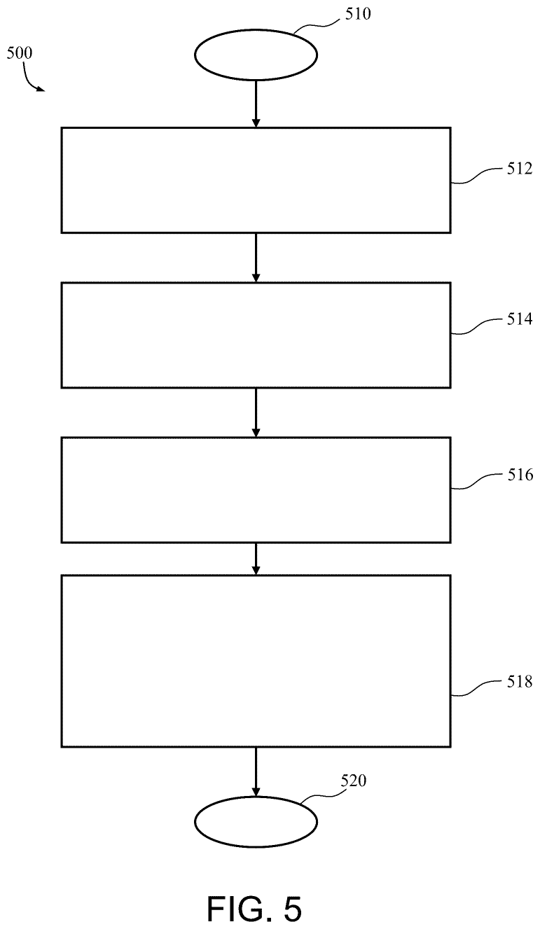

With reference now to FIG. 5 and with continued reference to FIGS. 1-4, a flowchart provides a method 500 for forming coated powder particles, in accordance with various examples. As can be appreciated in light of the disclosure, the order of operation within the method 500 is not limited to the sequential execution as illustrated in FIG. 5, but may be performed in one or more varying orders as applicable and in accordance with the present disclosure. In one example, the method 500 may start at 510.

At 512, the method 500 may include dissolving a dopant precursor and a reducing agent in an inorganic solvent to form a solution. At 514, the method 500 may include mixing particles of an electroactive material in the solution. At 516, the method 500 may include drying the mixture to remove the organic solvent and forming a coating layer on the particles which includes a dopant compound formed (formed the dopant precursor) and the reducing agent. At 518, the method 500 may include performing a heat treatment on the coated particles that is sufficient to reduce the dopant compound to form free radicals, to facilitate the free radicals to diffuse into the lattice of the electroactive materials, and to form a passivation layer on the particles of the electroactive material. The method 500 may end at 520.

The systems and methods disclosed herein provide various benefits over certain existing systems and methods. For example, calcinating the coated particles in the presence of fluorine provides for solid-state reaction and diffusion of the dopant material while simultaneously removing oxides of the dopant material that would otherwise form a coating on surfaces of the dopant material and increase the energy barrier for the solid-state reaction. Furthermore, in some examples the heat treatment produces a byproduct, fluoride, which may be utilized as an artificial SEI layer to prevent or reduce reactions between the electrolyte and transitional metals.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, comprising:
providing an initial powder material having initial particles that each include an electroactive material;
coating the initial particles with a doping compound that includes a dopant material to define coated particles of an intermediate powder material;
exposing the coated particles to a reducing agent; and
performing a heat treatment on the coated particles while exposed to the reducing agent at an elevated temperature and period of time sufficient to cause a solid-state reaction and diffusion of the dopant material into the electroactive material to form a doped region within the electroactive material and thereby define doped particles of a final powder material, wherein the doped region extends at least one nanometer into the electroactive material from an outermost surface thereof, wherein the reducing agent reacts with oxides formed on a surface of the coated particles during the heat treatment.

2. The method of claim 1, wherein the electroactive material is a nickel-, manganese-, cobalt-based oxide.

3. The method of claim 1, wherein providing the initial powder material includes:
forming a solution of an inorganic solvent and the dopant precursor;
mixing the initial powder material into the solution to form a mixture; and
drying the mixture to obtain the coated particles of the intermediate powder material, wherein the dopant material is formed from the dopant precursor,
wherein performing the heat treatment is sufficient to form free radicals from the dopant material and facilitate the diffusion of the free radials into the lattice of the electroactive material.

4. The method of claim 3, wherein the inorganic solvent includes dimethylformamide (DMF), dimethylacetamide (DMAc), dimethyl sulfoxide (DMSO), tetrahydrofuran (THF), various esters, or acetone.

5. The method of claim 3, wherein the solution further includes the reducing agent.

6. The method of claim 5, wherein the reducing agent includes fluorine.

7. The method of claim 5, wherein the reducing agent is a fluoropolymer that includes polyvinylfluoride (PVF), polyvinylidene fluoride (PVDF), polytetrafluoroethylene (PTFE), perfluoroalkoxy polymer (PFA), polychlorotrifluoroethylene (PCTFE), polyethylenetetrafluoroethylene (ETFE), or polyethylenechlorotrifluoroethylene (ECTFE).

8. The method of claim 1, wherein exposing the coated particles of the intermediate powder material includes exposing the intermediate powder material to a gaseous mixture that includes a fluoro monomer gas and an inert carrier gas.

9. The method of claim 8, wherein the gaseous mixture includes perfluorocycloalkene (PFCA), vinyl fluoride (fluoroethylene) (VF1), vinylidene fluoride (1,1-difluoroethylene) (VDF or VF2), tetrafluoroethylene (TFE), chlorotrifluoroethylene (CTFE), or hexafluoropropylene (HFP).

10. The method of claim 1, wherein the initial particles of the initial powder material each include a core material that includes the electroactive material and a coating layer overlying surfaces of the core material, wherein performing the heat treatment results in the dopant material being disposed within the core material adjacent to the surfaces thereof and having a concentration of less than 30 at. % within the coating layer.

11. The method of claim 10, wherein the reducing agent includes fluorine and the fluorine reacts with a lithium-containing compound during the heat treatment to form a passivation layer on the doped particles of the final powder material that defines an exterior surface of the doped particles.

12. The method of claim 1, wherein each of the doped particles of the final powder material include a coating layer overlying the doped region of the electroactive material, and a passivation layer overlying the coating layer, wherein the passivation layer includes a lithium-based material.

13. The method of claim 1, wherein the dopant material includes aluminum (Al), magnesium (Mg), titanium (Ti), gallium (Ga), zirconium (Zr), or vanadium (V), calcium (Ca), iron (Fe), chromium (Cr), molybdenum (Mo), silicon (Si), yttrium (Y), boron (B), or combinations thereof.

14. The method of claim 1, further comprising forming an electrode that includes a layered oxide structure that includes the doped particles of the final powder material.

15. A powder material including particles, each of the particles comprising:
a core material that includes a nickel-, manganese-, cobalt-based oxide;
a doped region in the core material that extends at least one nanometer into the core material from an outermost surface thereof, wherein the doped region includes the nickel-, manganese-, cobalt-based oxide and a dopant material diffused therein, wherein the dopant material includes aluminum (Al), magnesium (Mg), titanium (Ti), gallium (Ga), zirconium (Zr), or vanadium (V), calcium (Ca), iron (Fe), chromium (Cr), molybdenum (Mo), silicon (Si), yttrium (Y), boron (B), or combinations thereof; and
a coating layer overlying the outermost surface of the core material, wherein the coating layer has a concentration of the dopant material of less than 30 at. %.

16. The powder material of claim 15, further comprising a passivation layer overlying the coating layer that includes a lithium-based material.

17. The powder material of claim 15, wherein the coating layer includes carbon or a carbon-based compound.

18. An electrode having a layered oxide structure formed of a powder material having particles that each include a core material that includes a nickel-, manganese-, cobalt-based oxide and a coating layer overlying a surface of the core material, wherein the core material includes a dopant material disposed within a doped region of the core material adjacent to the surface thereof, wherein the dopant material includes aluminum (Al), magnesium (Mg), titanium (Ti), gallium (Ga), zirconium (Zr), or vanadium (V), calcium (Ca), iron (Fe), chromium (Cr), molybdenum (Mo), silicon (Si), yttrium (Y), boron (B), or combinations thereof, wherein the coating layer has a concentration of the dopant material of less than 30 at. %.

19. The electrode of claim 18, further comprising a passivation layer overlying the coating layer that includes a lithium-based material.

20. The electrode of claim 18, wherein the coating layer includes carbon or a carbon-based compound.
